(19) United States
(12) Patent Application Publication
(10) Pub. No.: US 2025/0196869 A1
(43) Pub. Date: Jun. 19, 2025

(54) INFORMATION PROCESSING DEVICE, STORAGE MEDIUM FOR STORING COMPUTER PROGRAM FOR INFORMATION PROCESSING, AND INFORMATION PROCESSING METHOD

(71) Applicant: TOYOTA JIDOSHA KABUSHIKI KAISHA, Toyota-shi Aichi-ken (JP)

(72) Inventor: Tomohiro HARA, Odawara-shi Kanagawa-ken (JP)

(73) Assignee: TOYOTA JIDOSHA KABUSHIKI KAISHA, Toyota-shi Aichi-ken (JP)

(21) Appl. No.: 18/983,873

(22) Filed: Dec. 17, 2024

(30) Foreign Application Priority Data
Dec. 19, 2023 (JP) 2023-213923

(51) Int. Cl. B60W 50/06

(52) U.S. Cl. CPC B60W 50/06; B60W 2050/065; B60W 2420/403; B60W 2555/00

(57) ABSTRACT

An information processing device has a collecting device that collects information relating to control of a vehicle for machine learning, wherein processing is carried out using hardware common to a detecting device that carries out detection processing for control of the vehicle, and a processor configured to estimate a degree of processing volume for detection processing by the detecting device, based on at least one type of information from among vehicle information representing a state of the vehicle, environment information representing surrounding environment of the vehicle and terrain information representing terrain including a current location of the vehicle, and to decide to lower detection accuracy by the detecting device when it has been estimated that processing volume for detection processing by the detecting device is low, compared to when it has been estimated that processing volume for detection processing by the detecting device is high.

### CROSS-REFERENCE TO RELATED APPLICATIONS

This application claims priority to Japanese Patent Application No. 2023-213923 filed Dec. 19, 2023, the entire contents of which are herein incorporated by reference.

### FIELD

The present disclosure relates to an information processing device, a storage medium for storing a computer program for information processing, and an information processing method.

### BACKGROUND

An automatic control device that controls a vehicle carries out control of the vehicle using a machine learning-trained classifier. When the vehicle is being driven automatically, the classifier is used in detection processing whereby the surrounding environment of the vehicle is detected, and in control processing whereby a signal is generated to control the vehicle.

When the vehicle is being manually driven, signals for control of the vehicle are generated based on operation by the driver. Training can further improve the classifying precision of the machine learning-trained classifier. The automatic control device collects information while the vehicle is being manually driven. The collected data is used as teacher data in order to further improve the classifier.

Japanese Unexamined Patent Publication No. H07-296210, for example, proposes collecting data at a sampling interval that varies with the traveling speed of the vehicle, in order to acquire more precise data.

### SUMMARY

An automatic control device carries out detection processing for detection of the surrounding environment of the vehicle and control processing of the vehicle when the vehicle is being manually driven, similar to when the vehicle is being self-driven.

An automatic control device is subjected to a load for detection processing and a load for collection of data relating to vehicle control for machine learning, and it is desirable to reduce this load on the automatic control device.

The processing volume for detection processing varies, depending on the surrounding environment of the vehicle. For example, the processing volume for detection processing is lower for a non-complex surrounding environment of the vehicle than for a complex surrounding environment of the vehicle. Since the surrounding environment of the vehicle is not complex when the processing volume for detection processing is low, even during self-driving of the vehicle, the effect on vehicle safety may be small, even if the detection accuracy for detection processing is lowered. Since the vehicle is controlled based on operation by the driver when the vehicle is being manually driven, there is likewise no effect on vehicle safety, even if the detection accuracy for detection processing is lowered.

It is therefore an object of the present disclosure to provide an information processing device that can reduce the load on hardware by lowering detection accuracy for detection processing when the processing volume for detection processing is low.

(1) According to one embodiment of the present disclosure there is provided an information processing device. The information processing device has a collecting device that collects information relating to control of a vehicle for machine learning, wherein processing is carried out using hardware common to a detecting device that carries out detection processing for control of the vehicle, and a processor configured to estimate a degree of processing volume for detection processing by the detecting device, based on at least one type of information from among vehicle information representing a state of the vehicle, environment information representing surrounding environment of the vehicle, and terrain information representing terrain including a current location of the vehicle, and decide to lower detection accuracy by the detecting device when it has been estimated that processing volume for detection processing by the detecting device is low, compared to when it has been estimated that processing volume for detection processing by the detecting device is high.

(2) In the information processing device according to (1), the vehicle information includes information representing a degree of operation of the vehicle, and the processor is further configured to estimate that the processing volume for detection processing by the detecting device is low when operation of the vehicle is slow, compared to when operation of the vehicle is fast.

(3) In the information processing device of embodiment (1) or (2), the environment information includes information representing a degree of complexity of the surrounding environment of the vehicle, and the processor is further configured to estimate that the processing volume for detection processing by the detecting device is low when the surrounding environment of the vehicle is not complex, compared to when the surrounding environment of the vehicle is complex.

(4) In the information processing device of any of embodiments (1) to (3), the terrain information includes information representing a degree of complexity of the terrain including the current location of the vehicle, and the processor is further configured to estimate that the processing volume for detection processing by the detecting device is low when the terrain including the current location of the vehicle is not complex, compared to when the terrain including the current location of the vehicle is complex.

(5) In the information processing device of any of embodiments (1) to (4), the processor is further configured to decide to lower detection accuracy by the detecting device by lengthening a cycle at which detection processing is carried out by the detecting device.

(6) In the information processing device of any of embodiments (1) to (5), the processor is further configured to decide to lower detection accuracy by the detecting device by reducing a number of sensors by which detected information is input to the detecting device.

(7) In the information processing device of any of embodiments (1) to (6), the processor is further configured to decide to lower detection accuracy by the detecting device by reducing a region in an image detected by the detecting device.

(8) In the information processing device of any of embodiments (1) to (7), the processor is further configured to decide to lower detection accuracy by the detecting device by reducing a distance of a trajectory of a moving object that is estimated by the detecting device.

(9) In the information processing device of any of embodiments (1) to (8), the detecting device has a first detecting device that can carry out detection processing independently, and a second detecting device that can carry out detection processing independently and has lower detection accuracy and lower load on hardware during operation than the first detecting device, and the processor is further configured to decide to use the second detecting device when the processing volume for detection processing by the detecting device has been estimated to be low, and to use the first detecting device when the processing volume for detection processing by the detecting device has been estimated to be high.

(10) In the information processing device of any of embodiments (1) to (9), the collecting device increases the processing volume for collection of information relating to vehicle control for machine learning, when it has been decided to lower detection accuracy by the detecting device.

(11) According to another embodiment there is provided a storage medium storing a computer program for information processing. The computer program for information processing causes a processor to execute a process, and the process includes estimating a degree of processing volume for detection processing by the detecting device that carries out detection processing for control of a vehicle, based on at least one type of information from among vehicle information representing a state of the vehicle, environment information representing surrounding environment of the vehicle and terrain information representing terrain including a current location of the vehicle, the processing being carried out using hardware common to a collecting device that collects information relating to control of a vehicle for machine learning and deciding to lower detection accuracy by the detecting device when it has been estimated that processing volume for detection processing by the detecting device is low, compared to when it has been estimated that processing volume for detection processing by the detecting device is high.

(12) According to yet another embodiment of the present disclosure, an information processing method is provided. The information processing method includes estimating a degree of processing volume for detection processing by the detecting device that carries out detection processing for control of a vehicle, based on at least one type of information from among vehicle information representing a state of the vehicle, environment information representing surrounding environment of the vehicle and terrain information representing terrain including a current location of the vehicle, the processing being carried out using hardware common to a collecting device that collects information relating to control of a vehicle for machine learning, and deciding to lower detection accuracy by the detecting device when it has been estimated that processing volume for detection processing by the detecting device is low, compared to when it has been estimated that processing volume for detection processing by the detecting device is high.

The information processing device of this disclosure can reduce the load on hardware by lowering detection accuracy for detection processing when the processing volume for detection processing is low, thereby allowing collection processing by a collecting unit to be improved.

The object of the present disclosure will be realized and attained by the elements and combinations particularly specified in the claims. It is to be understood that both the foregoing general description and the following detailed description are exemplary and explanatory and are not restrictive of the present disclosure, as claimed

### BRIEF DESCRIPTION OF DRAWINGS

FIG. 1 is a diagram illustrating operation of a control device of the embodiment in overview.

FIG. 2 is a hardware configuration diagram for a vehicle in which the control device of the embodiment is mounted.

FIG. 3 is an example of an operation flow chart for information processing by a control device.

FIG. 4 is another diagram illustrating decision processing by a deciding unit.

FIG. 5 is an example of an operation flow chart for collection processing by a control device.

### DESCRIPTION OF EMBODIMENTS

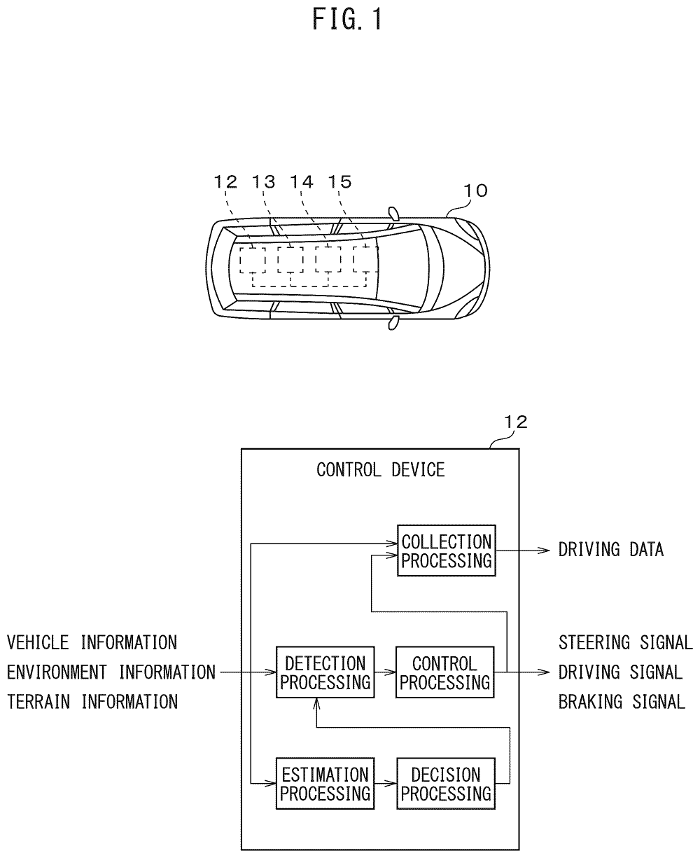

FIG. 1 is a diagram illustrating operation of a control device 12 of the embodiment in overview. Operation of the control device 12 of this embodiment will be explained in overview with reference to FIG. 1.

The vehicle 10 has a control device 12. The vehicle 10 supports manual driving and self-driving. When the vehicle 10 is manually driven, the control device 12 outputs a manual steering signal for control of a steering device 13, a manual driving signal for control of a drive unit 14 for the engine or motor, and a manual braking signal for control of a braking device 15, based on operation of the steering wheel, accelerator pedal and brake pedal by the driver.

When the vehicle 10 is self-driven, the control device 12 also inputs vehicle information representing the state of the vehicle 10, environment information representing the environment surrounding the vehicle 10, and terrain information representing the terrain including the current location of the vehicle 10, and outputs an automatic steering signal that controls the steering device 13, an automatic driving signal that controls the drive unit 14 such as an engine or motor, and an automatic braking signal that controls the braking device 15.

For example, the control device 12 carries out detection processing by which objects around the vehicle 10 are detected based on environment information. The control device 12 also carries out control processing that generates automatic steering signals, automatic driving signals and automatic braking signals based on vehicle information such as the speed of the vehicle 10, objects detected by detection processing, and map information included in terrain information.

When the vehicle 10 is manually driven, the control device 12 carries out collection processing whereby manual driving data is collected for training of the machine learning-trained classifier. The control device 12 collects the vehicle information, environment information and terrain information, and the manual steering signals, manual driving signals and manual braking signals, and generates driving information. The driving information is sent to an external server (not shown) and used as teacher data for training of a classifier.

The control device 12 also carries out detection processing and control processing when the vehicle 10 is being manually driven. When the vehicle 10 is being manually driven, however, the automatic steering signals, automatic driving signals and automatic braking signals generated by the control processing are not output to the steering device 13, drive unit 14 and braking device 15.

Detection processing and collection processing at the control device 12 are carried out using the same hardware. For example, detection processing and collection processing are carried out using a common processor.

For manual driving, the control device 12 carries out estimation processing by which it estimates the degree of processing volume for detection processing, based on at least one type of information from among vehicle information, environment information and terrain information.

When the processing volume for detection processing has been estimated to be low, the control device 12 carries out decision processing whereby the control device 12 decides to lower the detection accuracy for detection processing compared to when the processing volume for detection processing has been estimated to be high.

Since the detection accuracy is lowered, load on the hardware decreases. This allows the processing volume for collection processing to be increased.

The control device 12 may use the speed of the vehicle 10 as vehicle information, for example. The control device 12 lowers the detection accuracy for detection processing by lengthening the cycle for carrying out detection processing when the speed of the vehicle 10 is less than a predetermined reference speed, compared to when the speed of the vehicle 10 is equal to or greater than the reference speed.

When the vehicle 10 is being manually driven the vehicle 10 is controlled based on operation by the driver, and hence there is no effect on the safety of the vehicle 10, even if the detection accuracy for detection processing is lowered. The automatic steering signals, automatic driving signals and automatic braking signals generated based on the detection results are not used for control of the vehicle 10.

The control device 12 of the embodiment as described above can reduce the load on hardware by lowering detection accuracy for detection processing when the processing volume for detection processing is low, thereby allowing collection processing to be improved.

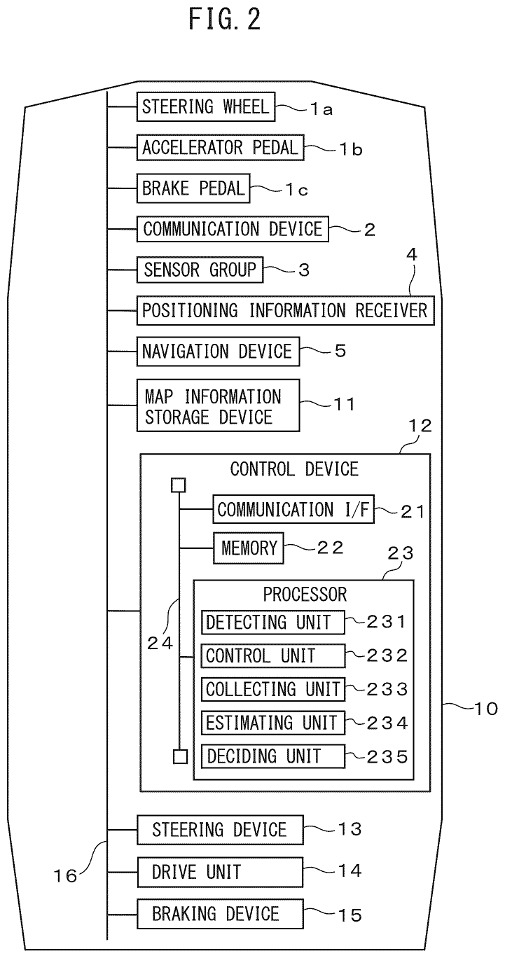

The vehicle 10 in which the control device 12 is mounted will now be explained with reference to FIG. 2, which is a hardware configuration diagram for a vehicle 10 in which the control device 12 of the embodiment is mounted.

The vehicle 10 has a steering wheel 1a, an accelerator pedal 1b, a brake pedal 1c, a communication device 2, a sensor group 3, a positioning information receiver 4, a navigation device 5, a map information storage device 11, a control device 12, a steering device 13, a drive unit 14 and a braking device 15.

The steering wheel 1a, accelerator pedal 1b, brake pedal 1c, communication device 2, sensor group 3, positioning information receiver 4, navigation device 5, map information storage device 11, control device 12, steering device 13, drive unit 14 and braking device 15 are connected in a communicable manner through an in-vehicle network 16 that conforms to controller area network standards.

The steering wheel 1a, operated by the driver, outputs a signal representing the steering angle of the steering wheel 1a to the control device 12, via the in-vehicle network 16.

The accelerator pedal 1b, operated by the driver, outputs a signal representing the degree of operation of the accelerator pedal 1b to the control device 12, via the in-vehicle network 16.

The brake pedal 1c, operated by the driver, outputs a signal representing the degree of operation of the brake pedal 1c to the control device 12, via the in-vehicle network 16.

The communication device 2 has an interface circuit for connection of the control device 12 to a communication network (not shown) via a macrocell base station (not shown). The control device 12 is able to communicate with the external server which is connected to the communication network, via the communication device 2.

The sensor group 3 has a plurality of sensors for detection of vehicle information, environment information and terrain information. For example, the sensor group 3 has a speed sensor for detection of information representing the speed of the vehicle 10, an acceleration sensor for detection of acceleration and an angular velocity sensor for detection of angular velocity, as sensors for detection of vehicle information.

The sensor group 3 also has a front camera, rear camera, LiDAR sensor, millimeter wave radar sensor and ultrasonic sensor, for example, as sensors for detection of environment information. The front camera acquires images representing the environment in a predetermined range ahead of the vehicle 10. The rear camera acquires images representing the environment in a predetermined range behind the vehicle 10. The LiDAR sensor acquires reflected wave information representing laser-reflecting objects surrounding the vehicle 10. The millimeter wave radar sensor acquires reflected wave information representing millimeter wave-reflecting objects surrounding the vehicle 10. The ultrasonic sensor acquires reflected wave information representing ultrasonic wave-reflecting objects surrounding the vehicle 10.

The front camera, and the millimeter wave radar that detects the environment ahead of the vehicle 10, are examples of front sensors that detect environment information ahead of the vehicle 10. The rear camera, and the millimeter wave radar that detects the environment behind the vehicle 10, are examples of rear sensors that detect environment information behind the vehicle 10. The millimeter wave radar and LiDAR sensors that detect the environment to the sides of the vehicle 10, are examples of side sensors that detect environment information to the sides of the vehicle. The ultrasonic sensor is an example of an ambient sensor that detects environment information in the surrounding neighborhood of the vehicle.

The sensors that detect environment information, such as the front camera and LiDAR sensors, are also used as sensors for acquiring terrain information representing the roads around the vehicle 10.

The sensor group 3 outputs the information detected by the sensors to the control device 12 via the in-vehicle network 16.

The positioning information receiver 4 outputs positioning information that represents the current location of the vehicle 10. The positioning information receiver 4 may be a GNSS receiver, for example. The positioning information receiver 4 outputs positioning information and the positioning information acquisition time at which the positioning information has been acquired, to the navigation device 5 and map information storage device 11, each time positioning information is acquired at a predetermined receiving cycle.

Based on the navigation map information, the destination location of the vehicle 10, and positioning information representing the current location of the vehicle 10 input from the positioning information receiver 4, the navigation device 5 creates a navigation route from the current location to the destination location of the vehicle 10. When the destination location has been newly set or the current location of the vehicle 10 has exited the navigation route, the navigation device 5 creates a new navigation route for the vehicle 10. Every time a navigation route is created, the navigation device 5 outputs the navigation route to the control device 12, for example, via the in-vehicle network 16.

The map information storage device 11 stores wide-area map information for a relatively wide area (an area of 10 to 30 km², for example) that includes the current location of the vehicle 10. In some embodiments, the map information has high-precision map information including three-dimensional information for the road surface, the speed limit for the road, the curvature of the road, and information for the types and locations of structures and road features such as road lane marking lines. A single lane is represented in the map information as a series of a plurality of lane links. The map information also includes the types of roads. The road type indicates whether the road is a motorway or a general road.

The map information storage device 11 receives the wide-area map information from an external server (not shown) via a macrocell base station (not shown), by wireless communication through a communication device 2 mounted in the vehicle 10, in relation to the current location of the vehicle 10, and stores it in the storage device. Each time positioning information is input from the positioning information receiver 4, the map information storage device 11 refers to the stored wide-area map information and outputs map information for a relatively narrow area including the current location represented by the positioning information (for example, an area of 100 m² to 10 km²), through the in-vehicle network 16 to the control device 12. The map information is an example of terrain information.

The vehicle control device 12 carries out detection processing, control processing, collection processing, estimation processing and decision processing. For this purpose, the control device 12 has a communication interface (IF) 21, a memory 22 and a processor 23. The communication interface 21, memory 22 and processor 23 are connected via signal wires 24. The communication interface 21 has an interface circuit to connect the vehicle control device 12 with the in-vehicle network 16.

The memory 22 is an example of a storage unit, and it has a volatile semiconductor memory and a non-volatile semiconductor memory, for example. The memory 22 stores an application computer program and various data to be used for information processing carried out by the processor 23 of each device.

All or some of the functions of the control device 12 are functional modules driven by a computer program operating on the processor 23, for example. The processor 23 has a detecting unit 231, a control unit 232, a collecting unit 233, an estimating unit 234 and a deciding unit 235. Alternatively, the functional module of the processor 23 may be a specialized computing circuit in the processor 23. The processor 23 has one or more CPUs (Central Processing Units) and their peripheral circuits. The processor 23 may also have other computing circuits such as a logical operation unit, numerical calculation unit or graphics processing unit. The control device 12 is an electronic control unit (ECU), for example.

The detecting unit 231 carries out detection processing by which the detecting unit 231 detects the state of the vehicle 10, such as its speed, acceleration and angular velocity, based on vehicle information. The detecting unit 231 carries out detection processing by which the detecting unit 231 determines the current location and orientation of the vehicle 10, based on terrain information and environment information. The detecting unit 231 carries out detection processing by which objects around the vehicle 10 are detected based on environment information. Such objects include moving objects such as other vehicles and pedestrians, as well as structures such as guard rails. The detecting unit 231 tracks detected moving objects and determines the trajectories and speeds of the objects. A machine learning-trained classifier may also be used for detection processing.

The detecting unit 231 also carries out detection processing whereby the detecting unit 231 detects road features such as lane marking lines, signs and traffic lights, based on the environment information. The detecting unit 231 carries out detection processing by which the detecting unit 231 detects construction zones based on environment information.

The detecting unit 231 carries out detection processing by which roads around the vehicle 10 are detected based on terrain information.

When the vehicle 10 is being self-driven, the control unit 232 carries out control processing in which the control unit 232 generates a traveling lane plan representing the scheduled traveling lane in which the vehicle 10 is to travel, based on the current location of the vehicle 10, the navigation route, and the vehicle information, environment information and terrain information. The control unit 232 also carries out control processing in which the control unit 232 generates a driving plan representing a scheduled traveling trajectory for the vehicle 10 until a predetermined time (such as 5 seconds), based on the traveling lane plan.

When the vehicle 10 is being self-driven, the control unit 232 controls each unit of the vehicle 10 based on the driving plan. The control unit 232 generates an automatic steering signal for control of the steering device 13 that controls the steering wheel of the vehicle 10, based on the driving plan. The control unit 232 generates an automatic driving signal that controls a drive unit 14 such as an engine or motor of the vehicle 10, based on the driving plan. The control unit 232 also generates an automatic braking signal that controls the braking device 15 of the vehicle 10, based on the driving plan. The control unit 232 outputs the automatic steering signal, automatic driving signal or automatic braking signal to the steering device 13, drive unit 14 or braking device 15, via the in-vehicle network 16. A machine learning-trained classifier may also be used for this control processing.

When the vehicle 10 is being manually driven, the control unit 232 generates a manual steering signal, manual driving signal and manual braking signal based on information representing the steering angle of the steering wheel 1a, information representing the degree of operation of the accelerator pedal 1b, and information representing the degree of operation of the brake pedal 1c. The control unit 232 outputs the manual steering signal, manual driving signal or manual braking signal to the steering device 13, drive unit 14 or braking device 15, via the in-vehicle network 16. The manual steering signal, manual driving signal and manual braking signal are sent to the collecting unit 233 as well.

Even when the vehicle 10 is being manually driven, the control unit 232 generates the automatic steering signal, automatic driving signal and automatic braking signal and sends them to the collecting unit 233. However, the automatic steering signal, automatic driving signal and automatic braking signal are not output to the steering device 13, drive unit 14 or braking device 15.

Processing is carried out by the detecting unit 231 and the collecting unit 233 using the same hardware. The detecting unit 231 and collecting unit 233 have common hardware (processor and memory) for at least some of their components. Reducing the processing volume of the detecting unit 231 can therefore increase processing volume for the collecting unit 233.

For this embodiment, the detecting unit 231, control unit 232, collecting unit 233, estimating unit 234 and deciding unit 235 carry out processing using common hardware.

For FIG. 2, the map information storage device 11 and the control device 12 were described as separate devices, but these may also be constructed as a single device.

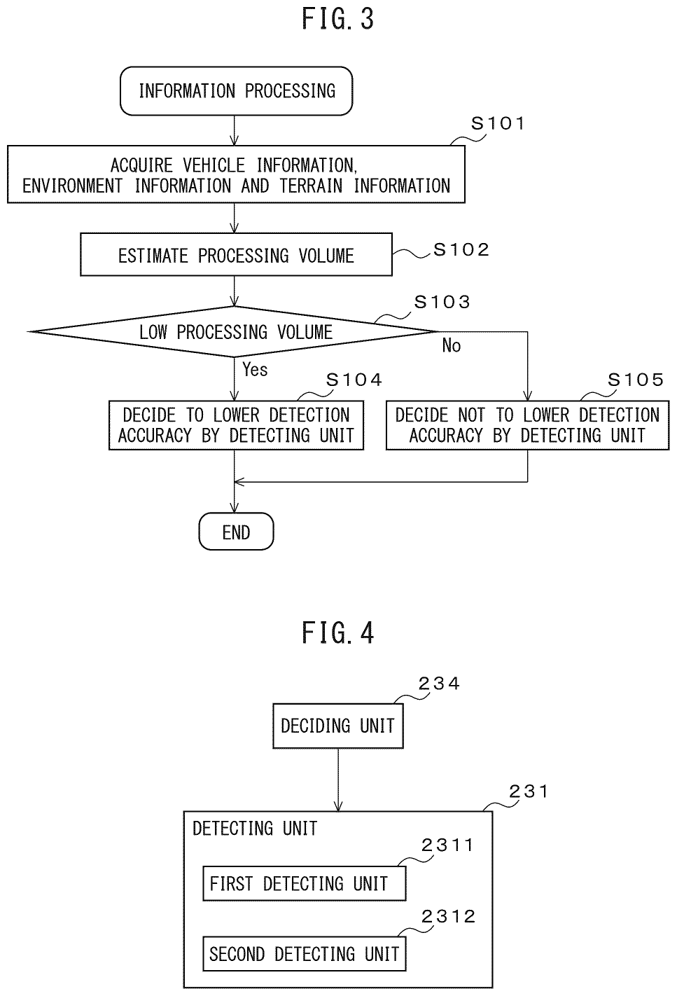

FIG. 3 is an example of an operation flow chart for information processing by the control device 12. Information processing by the control device 12 will be described with reference to FIG. 3. The control device 12 carries out information processing according to the operation flow chart shown in FIG. 3, at an information processing time having a predetermined cycle.

First, the estimating unit 234 acquires vehicle information, environment information and terrain information (step S101). The vehicle information, environment information and terrain information are input to the control device 12 through the in-vehicle network 16.

The estimating unit 234 then estimates the degree of processing volume for detection processing for the detecting unit 231 based on one or more information types from among the vehicle information, environment information and terrain information (step S102). The estimating unit 234 may also estimate the degree of processing volume for detection processing for the detecting unit 231 based on multiple information types from among the vehicle information, environment information and terrain information. Estimation processing by the estimating unit 234 is described below.

The deciding unit 235 then assesses whether the processing volume for detection processing by the detecting unit 231 has been estimated by the estimating unit 234 to be low, or high (step S103).

When the processing volume for detection processing has been estimated by the estimating unit 234 to be low (step S103—Yes), the deciding unit 235 decides to lower detection accuracy by the detecting unit 231, compared to when the processing volume for detection processing by the detecting unit 231 has been estimated to be high (step S104), and the series of processing steps is complete.

When it has been decided by the deciding unit 235 to lower the detection accuracy by the detecting unit 231, the detecting unit 231 carries out detection processing with detection accuracy lowered from the default accuracy.

When the processing volume for detection processing has been estimated by the estimating unit 234 to be high (not low) (step S103—No), on the other hand, the deciding unit 235 decides not to lower detection accuracy by the detecting unit 231 (step S105), and the series of processing steps is complete. Decision processing by the deciding unit 235 is described below.

When it has been decided by the deciding unit 235 not to lower the detection accuracy by the detecting unit 231, the detecting unit 231 carries out detection processing with the default detection accuracy.

Estimation processing by the estimating unit 234 will now be explained.

The vehicle information includes information representing the degree of operation of the vehicle 10. For example, the vehicle information includes the speed of the vehicle 10, the amount of change in the steering angle per unit time, and the number of brakings per unit time.

The estimating unit 234 estimates that the processing volume for detection processing by the detecting unit 231 is lower when operation of the vehicle 10 is slow, compared to when operation of the vehicle 10 is fast.

The estimating unit 234 estimates that the processing volume for detection processing by the detecting unit 231 is lower when the speed of the vehicle 10 is less than a reference speed, compared to when the speed of the vehicle 10 is equal to or greater than the reference speed. When the speed of the vehicle 10 is less than the reference speed, fewer changes occur in the environment within the visual fields of the sensors, and therefore the numbers of objects and road features detected by the detecting unit 231 per unit time are estimated to be lower. The speed of the vehicle 10 may be the average speed of the vehicle 10 during the most recent predetermined period.

The estimating unit 234 estimates that the processing volume for detection processing by the detecting unit 231 is low when the amount of change in the steering angle per unit time is less than a reference angle, compared to when the amount of change in the steering angle per unit time is equal to or greater than the reference angle. When the amount of change in the steering angle per unit time is less than the reference angle, fewer changes occur in the environment represented in the visual fields of the sensors, and therefore the numbers of objects and road features detected by the detecting unit 231 per unit time are estimated to be lower.

The estimating unit 234 estimates that the processing volume for detection processing by the detecting unit 231 is low when the number of brakings per unit time is less than a reference value, compared to when the number of brakings per unit time is equal to or greater than the reference value. When the number of brakings per unit time is less than the reference value, it is estimated either that fewer objects are present around the vehicle 10, or that the vehicle 10 is traveling on a straight road. Therefore when the number of brakings per unit time is less than the reference value, fewer changes occur in the environment represented in the visual fields of the sensors, and consequently the numbers of objects and road features detected by the detecting unit 231 per unit time are estimated to be lower.

Environment information includes information representing the degree of complexity of the surrounding environment of the vehicle 10. For example, the environment information includes the number of moving objects around the vehicle 10, the number of road features around the vehicle 10, and the presence or absence of a construction zone around the vehicle 10.

The estimating unit 234 estimates that the processing volume for detection processing by the detecting unit 231 is lower for a non-complex environment surrounding the vehicle 10 than for a complex environment surrounding the vehicle 10.

The estimating unit 234 estimates that the processing volume for detection processing by the detecting unit 231 is low when the number of moving objects around the vehicle 10 is less than a reference value, compared to when the number of moving objects around the vehicle 10 is equal to or greater than the reference value. When the number of moving objects around the vehicle 10 is less than the reference value, it is estimated that a lower number of moving objects are detected by the detecting unit 231 per unit time. For example, when the vehicle 10 is traveling on a non-congested road, the estimating unit 234 estimates that the processing volume for detection processing by the detecting unit 231 is lower than when the vehicle 10 is traveling on a congested road.

The estimating unit 234 estimates that the processing volume for detection processing by the detecting unit 231 is low when the number of road features around the vehicle 10 is less than a reference value, compared to when the number of road features around the vehicle 10 is equal to or greater than the reference value. When the number of road features around the vehicle 10 is less than the reference value, it is estimated that a lower number of road features are detected by the detecting unit 231 per unit time.

The estimating unit 234 estimates that the processing volume for detection processing by the detecting unit 231 is lower when no construction zone is present around the vehicle 10, compared to when a construction zone is present around the vehicle 10. Since traffic lane restriction signs related to construction may be present when a construction zone is present around the vehicle 10, it is estimated that a greater number of road features are detected by the detecting unit 231 per unit time.

Terrain information includes information representing the degree of complexity of the terrain that includes the current location of the vehicle 10. For example, the terrain information includes the number of lane links around the vehicle 10, the curvature of the road and the type of road.

The estimating unit 234 estimates that the processing volume for detection processing by the detecting unit 231 is lower for a non-complex terrain around the vehicle 10 than for a complex terrain around the vehicle 10.

The estimating unit 234 estimates that the processing volume for detection processing by the detecting unit 231 is low when the number of lane links around the vehicle 10 is less than a reference value, compared to when the number of lane links around the vehicle 10 is equal to or greater than the reference value. The number of lane links around the vehicle 10 is increased near a road with many lanes or intersections. When the number of lane links around the vehicle 10 is less than the reference value, it is estimated that a lower number of road features are detected by the detecting unit 231 per unit time.

The estimating unit 234 estimates that the processing volume for detection processing by the detecting unit 231 is low when the curvature of the road around the vehicle 10 is less than a reference value, compared to when the curvature of the road around the vehicle 10 is equal to or greater than the reference value. When the curvature of the road around the vehicle 10 is less than the reference value it is estimated that the vehicle 10 is traveling on a relatively straight road. When the vehicle 10 is traveling on a relatively straight road, fewer changes occur in the environment represented by the visual fields of the sensors, and therefore changes in the objects and road features detected by the detecting unit 231 per unit time are estimated to be fewer.

When the vehicle 10 is traveling on a motorway, the estimating unit 234 estimates that the processing volume for detection processing by the detecting unit 231 is lower than when the vehicle 10 is not traveling on a motorway (is traveling on a general road). Because a general road has a large number of moving objects such as pedestrians and bicycles, stationary objects such as stopped vehicles and road features such as signs, the detection processing is estimated to be greater than on a motorway.

The estimating unit 234 may also estimate the degree of processing volume for detection processing by the detecting unit 231 based on multiple information types from among the vehicle information, environment information and terrain information. For example, the degree of processing volume for detection processing is estimated based on speed and number of moving objects, using a table associating the speed of the vehicle 10 as vehicle information and the number of moving objects as environment information, with the degree of processing volume for detection processing.

Decision processing by the deciding unit 235 will now be explained.

For example, the deciding unit 235 decides to lower the detection accuracy by the detecting unit 231, by lengthening the cycle by which detection processing is carried out by the detecting unit 231. The deciding unit 235 lengthens the cycle by which the front camera and rear camera acquire images. The deciding unit 235 also lengthens the cycles by which the LiDAR sensor, millimeter wave radar sensor or ultrasonic sensor acquire reflected wave information.

The deciding unit 235 may also decide to lower the detection accuracy by the detecting unit 231 by reducing the number of sensors through which detected information is input to the detecting unit 231.

The sensor group 3 mentioned above has a front sensor, ambient sensor, rear sensor and side sensor. A priority value is set for each of these sensors. The priority for the front sensor is 4, the priority for the ambient sensor is 3, the priority for the rear sensor is 2 and the priority for the side sensor is 1. A higher number signifies higher priority.

The number of sensors by which detected information is input to the detecting unit 231 may also be reduced in such a manner that only information detected by sensors with high priority is input to the detecting unit 231. For example, when detection accuracy by the detecting unit 231 is to be lowered, adjustment may be made so that only information detected by the front sensor is input to the detecting unit 231.

The deciding unit 235 may also decide to lower the detection accuracy by the detecting unit 231 by reducing a region within an image detected by the detecting unit 231. The images may be images acquired by the front camera or rear camera. For example, detection accuracy by the detecting unit 231 can be lowered by detecting only the center regions of the images.

The deciding unit 235 may also decide to lower the detection accuracy by the detecting unit 231 by decreasing a distance of a trajectory of a moving object that is estimated by the detecting unit 231. For example, processing by which the trajectory of a moving object have been estimated up to 5 seconds ahead may be changed to processing for estimation of the trajectory of a moving object up to 2 seconds ahead.

FIG. 4 is another diagram illustrating decision processing by a deciding unit. In this example, the detecting unit 231 has a first detecting unit 2311, and a second detecting unit 2312 with lower detection accuracy and lower load on the hardware during operation than the first detecting unit 2311. The first detecting unit 2311 and second detecting unit 2312 each carry out detection processing independently.

The first detecting unit 2311 and second detecting unit 2312 each have a classifier that includes a deep neural network (DNN), but the number of hidden layers in the DNN of the first detecting unit 2311 is greater than that of the DNN of the second detecting unit 2312.

The deciding unit 235 decides to use the second detecting unit 2312 when it has been estimated by the estimating unit 234 that the processing volume for detection processing by the detecting unit 231 is low, and decides to use the first detecting unit 2311 when it has been estimated by the estimating unit 234 that the processing volume for detection processing by the detecting unit 231 is high.

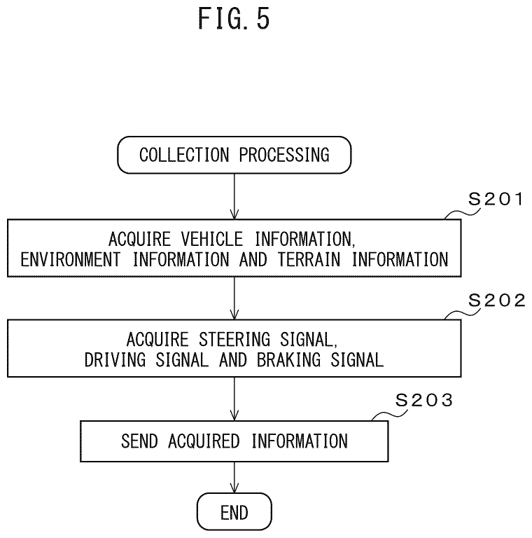

FIG. 5 is an example of an operation flow chart for collection processing by the control device 12. Collection processing by the control device 12 will be described with reference to FIG. 5. When the vehicle 10 is being manually driven, the control device 12 carries out collection processing according to the operation flow chart shown in FIG. 5, at a collection processing time having a predetermined cycle.

First, the collecting unit 233 acquires vehicle information, environment information and terrain information (step S201). The vehicle information, environment information and terrain information are input to the control device 12 through the in-vehicle network 16. The collecting unit 233 may also collect vehicle information, environment information and terrain information comprehensively over a predetermined collection period.

The collecting unit 233 then acquires a manual steering signal, manual driving signal, manual braking signal, automatic steering signal, automatic driving signal and automatic braking signal (step S202). The manual steering signal, manual driving signal, manual braking signal, automatic steering signal, automatic driving signal and automatic braking signal are sent from the control unit 232 to the collecting unit 233. In step S202, the manual steering signal, manual driving signal, manual braking signal, automatic steering signal, automatic driving signal and automatic braking signal may also be collected over a predetermined collection period.

The processing in step S202 may also be carried out before step S201. Alternatively, the processing in step S202 may be carried out simultaneously with step S201.

In step S201 or S202, if the deciding unit 235 has decided to lower the detection accuracy by the detecting unit 231, the collecting unit 233 may increase the processing volume by which it collects information relating to control of the vehicle 10 for machine learning. For example, the collecting unit 233 may shorten the cycle for carrying out collection processing. This will allow teacher data to be acquired at higher resolution.

The collecting unit 233 then sends the driving information including the vehicle information, environment information, terrain information, manual steering signal, manual driving signal, manual braking signal, automatic steering signal, automatic driving signal and automatic braking signal, via the communication device 2 to the external server (step S203), and the series of processing steps is complete. At the external server, the vehicle information, environment information, terrain information, manual steering signal, manual driving signal and manual braking signal are used as teacher data to train the classifier. The automatic steering signal, automatic driving signal and automatic braking signal may also be compared with the manual steering signal, manual driving signal and manual braking signal, for comparison between control with the current self-driving and with manual driving.

In the collection processing shown in FIG. 5, driving information collected during a predetermined collection period may also be sent together to the server. For the collection processing shown in FIG. 5, signals for operation of the steering wheel 1a, accelerator pedal 1b and brake pedal 1c by the driver may be collected and sent to the server.

The collection processing of FIG. 5 may also be carried out while the vehicle 10 is being self-driven. For example, in some cases, the driver may intervene during operation while the vehicle 10 is being self-driven. The operation data for such intervention of the driver during self-driving may also be collected as teacher data.

The decision device of the embodiment as described above can reduce the load on hardware by lowering detection accuracy by the detecting unit when the processing volume for detection processing by the detecting unit is low, thereby allowing collection processing by the collecting unit to be improved.

The information processing device, computer program for information processing and information processing method of the aforementioned embodiments of the present disclosure may incorporate appropriate modifications that are still within the gist of the present disclosure. Moreover, the technical scope of the present disclosure is not limited to the embodiments described herein and includes the present disclosure and its equivalents as laid out in the Claims.

For example, the collecting unit may collect information acquired from other vehicles around the vehicle, by way of a communication device. Such information may include events occurring ahead in the traveling direction of the vehicle. Such events may be traffic congestion information, or the presence of another vehicle stopped beyond a blind curve. The collecting unit may also send information acquired from other vehicles to an external server.

1. An information processing device comprising:
a collecting device that collects information relating to control of a vehicle for machine learning, wherein processing is carried out using hardware common to a detecting device that carries out detection processing for control of the vehicle; and
a processor configured to
estimate a degree of processing volume for detection processing by the detecting device, based on at least one type of information from among vehicle information representing a state of the vehicle, environment information representing surrounding environment of the vehicle, and terrain information representing terrain including a current location of the vehicle, and
decide to lower detection accuracy by the detecting device when it has been estimated that processing volume for detection processing by the detecting device is low, compared to when it has been estimated that processing volume for detection processing by the detecting device is high.

2. The information processing device according to claim 1, wherein
the vehicle information includes information representing degree of operation of the vehicle, and
the processor is further configured to estimate that the processing volume for detection processing by the detecting device is low when operation of the vehicle is slow, compared to when operation of the vehicle is fast.

3. The information processing device according to claim 1, wherein
the environment information includes information representing degree of complexity of the surrounding environment of the vehicle, and
the processor is further configured to estimate that the processing volume for detection processing by the detecting device is low when the surrounding environment of the vehicle is not complex, compared to when the surrounding environment of the vehicle is complex.

4. The information processing device according to claim 1, wherein
the terrain information includes information representing degree of complexity of the terrain including the current location of the vehicle, and
the processor is further configured to estimate that the processing volume for detection processing by the detecting device is low when the terrain including the current location of the vehicle is not complex, compared to when the terrain including the current location of the vehicle is complex.

5. The information processing device according to claim 1, wherein the processor is further configured to decide to lower detection accuracy by the detecting device by lengthening a cycle at which detection processing is carried out by the detecting device.

6. The information processing device according to claim 1, wherein the processor is further configured to decide to lower detection accuracy by the detecting device by reducing a number of sensors by which detected information is input to the detecting device.

7. The information processing device according to claim 1, wherein the processor is further configured to decide to lower detection accuracy by the detecting device by reducing a region in an image detected by the detecting device.

8. The information processing device according to claim 1, wherein the processor is further configured to decide to lower detection accuracy by the detecting device by reducing a distance of a trajectory of a moving object that is estimated by the detecting device.

9. The information processing device according to claim 1, wherein
the detecting device has a first detecting device that can carry out detection processing independently, and a second detecting device that can carry out detection processing independently and has lower detection accuracy and lower load on hardware during operation than the first detecting device, and
the processor is further configured to decide to use the second detecting device when the processing volume for detection processing by the detecting device has been estimated to be low, and to use the first detecting device when the processing volume for detection processing by the detecting device has been estimated to be high.

10. The information processing device according to claim 1, wherein the collecting device increases the processing volume for collection of information relating to vehicle control for machine learning, when it has been decided to lower detection accuracy by the detecting device.

11. A computer-readable non-transitory storage medium storing a computer program for information processing, which causes a processor to execute a process, and the process comprises:
estimating a degree of processing volume for detection processing by a detecting device that carries out detection processing for control of a vehicle, based on at least one type of information from among vehicle information representing a state of the vehicle, environment information representing surrounding environment of the vehicle and terrain information representing terrain including a current location of the vehicle, the processing being carried out using hardware common to a collecting device that collects information relating to control of a vehicle for machine learning; and
deciding to lower detection accuracy by the detecting device when it has been estimated that processing volume for detection processing by the detecting device is low, compared to when it has been estimated that processing volume for detection processing by the detecting device is high.

12. An information processing method carried out by an information processing device and the method comprises:
estimating a degree of processing volume for detection processing by a detecting device that carries out detection processing for control of a vehicle, based on at least one type of information from among vehicle information representing a state of the vehicle, environment information representing surrounding environment of the vehicle and terrain information representing terrain including a current location of the vehicle, the processing being carried out using hardware common to a collecting device that collects information relating to control of a vehicle for machine learning; and
deciding to lower detection accuracy by the detecting device when it has been estimated that processing volume for detection processing by the detecting device is low, compared to when it has been estimated that processing volume for detection processing by the detecting device is high.
